(19) United States
(12) Patent Application Publication
(10) Pub. No.: US 2017/0032717 A1
(43) Pub. Date: Feb. 2, 2017

(54) LIGHT EMITTING DIODE (LED) BACKLIGHTING SOURCE

(71) Applicant: Spiros Michaelidis, Seaford (AU)

(72) Inventor: Spiros Michaelidis, Seaford (AU)

(21) Appl. No.: 14/815,957

(22) Filed: Aug. 1, 2015

(51) Int. Cl. G09F 13/04; F21V 19/00

(52) U.S. Cl. CPC G09F 13/04; F21V 19/003; F21Y 2101/02; F21Y 2105/003

(57) ABSTRACT

A light emitting diode (LED) backlighting source comprising at least one circuit board electrically connectable to a power source; a plurality of LEDs electrically mounted on the circuit board and able to be powered by a connected power source; wherein the circuit board is formed of a plurality of spaced finger portions and connecting portions wherein the finger portions and the connecting portions are electrically connected.

### TECHNICAL FIELD

The present invention relates to a light emitting diode (LED) backlighting source.

More particularly, the present invention relates to a modular structure of an LED light source for backlighting a translucent or semitranslucent substrate to provide a substantially uniform box light source. This can be used in advertising, in general illumination or in decorative light sources but is not so limited.

### PRIOR ART

Light sources are generally a point source such as provided by incandescent lights, argon lights and other light globe structures. This form of light therefore irradiates from a small linear filament source which produces a substantially point source of light, if a large area is required to be illuminated then multiple point sources are required or light dispersion techniques are required such as by use of configurations of reflectors or Fresnel lenses or the like. Generally due to the bulkiness of such lights it is not practical to mount a plurality of such lights in order to give a substantially even spread of light.

To provide a more consistent light source there has generally been the use of tubular lights. This can include multiple fixed elongated fluorescent lights or it could include a continuous snaking neon tube Such systems can be used to provide an open light source where the tubes are visible and due to their relative positions can provide a required backlighting of a panel substrate to form a light box.

A problem with these fluorescent and neon lights are that they are costly to manufacture and they are costly to run and can be quite readily damaged. They require large power Source and ballast in order to maintain correct electrical conditions. Further the fluorescent or neon material can readily expire in a relatively short period.

The recent development of LED technology has enabled greater use and flexibility of light sources, Generally LEDs are appearing in a wide range of locations due to their low cost of manufacture but particularly due to their low energy use.

However clearly the use of LEDs has resulted in a return to the problem of light point sources and further problems occur due to the electronic nature of LEDs rather than usual electrical considerations of prior devices, In particular there is the problem of use of circuit boards to provide an array of LEDs. This is restrictive in size and arrangement and costly in manufacture.

Further problems occur when using LEDs in light boxes as limitation of arrangement of the LEDs causes inconsistent illumination of a backlit substrate. Consequently, when such an LED light box is used in advertising, in general illumination or in decorative light sources then unwanted light interference patterns or light dispersion patterns occur which affects the intended single light box illumination effect that was wanted.

Apart from aesthetic limitation there is also practical limitation as an inconsistent light source either provides a restricted general illumination from the backlighting of the translucent or semitranslucent substrate or provides a difficult to read backlit translucent or semitranslucent substrate that could include advertising material, or other information.

The present invention seeks to provide a light emitting diode (LED) backlighting source, which will overcome or substantially ameliorate at least one or more of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

In accordance with the invention there is provided a light emitting diode (LED) backlighting source comprising:

a. at least one circuit board electrically connectable to a power source;
b. a plurality of LEDs electrically mounted on the circuit board and able to be powered by a connected power source;
c. wherein the circuit board is fanned of a plurality of spaced finger portions and connecting portions wherein the finger portions and the connecting portions are electrically connected.

An advantage of the instant invention is that there is a very significant cost savings in reduced material required for manufacturing a circuit board, as well as space saving for transport. The finger portions allow manufacturing at a significantly reduced cost because less material is required for manufacturing a printed circuit board of a given size compared to the prior art.

Preferably the light emitting diode (LED) backlighting source has at least two circuit boards that have a shape and electrical configuration of the finger portions and the connecting portions to engage and to electrically connect the at least two circuit boards. The at least two circuit boards can have a substantially similar shape to each other. In one form the at least two circuit boards are hand portions formed by at least one connecting portion and a plurality of LED's electrically mounted on the circuit board and able to be powered by the connected power source.

In use the at least two circuit boards electrically can connect the finger portions of one to the finger portions of another to form the array of the light emitting diode (LED) backlighting source. Preferably the at least two circuit boards electrically connect the end tip of finger portions of one to the end tip of finger portions of another. The finger portions introduce an element of flexibility to the circuit board thus formed, which allows some movement to accommodate expansion or contraction with temperature fluctuations that otherwise cause conventional printed circuit board to warp or fracture.

The at least two circuit boards can be formed integrally in a first configuration as a single circuit board with a first footprint and can be separated and reconnected to form the at least two circuit boards with a second footprint greater than the first footprint and engage and electrically connect the at least two circuit boards in the second configuration.

Preferably the at least two circuit boards are formed in a first configuration.

Preferably the at least two circuit boards are complementary in shape. Preferably, each of the two circuit boards can form a multi-fingered E-shape wherein each circuit board is formed of a plurality of spaced finger portions and connecting portions. The finger portions and the connecting portions are therefore electrically connected but the finger portions have spacings therebetween of no circuit board.

The finger portions of the at least two circuit boards can be attached to each other by frangible means to form a configuration for manufacture having a first footprint. The frangible means allows the fingers to be separated, and thereafter reconnected to form a circuit board having a second footprint greater than the first footprint.

The at least two circuit boards can be the same shape.

The at least two circuit boards can be formed from a substantially rectangular circuit board. The LEDs are electrically mounted on the circuit board in a spaced arrangement to enhance constant illumination over the footprint of the circuit board.

Preferably a display array is formed of a plurality of circuit boards wherein at least two circuit boards are formed integrally in a first configuration as a single circuit board with a first footprint and can be separated and reconnected to form the at least two circuit boards with a second footprint greater than the first footprint and engage and electrically connect the at least two circuit boards in the second configuration. Large backlighting circuit boards can be easily manufactured from the plurality of circuit boards without the commensurate high cost of a conventional circuit board.

The plurality of LEDs on the circuit board can be substantially equally spaced from each other on the circuit board. Compared to the prior art, the equal spacings of the instant invention allows the substrate to be located closer to the LED's.

Preferably the plurality of LEDs on the circuit board are substantially equally spaced from each other over the plurality of spaced finger portions

Preferably the plurality of LEDs are spaced and offset to each other to provide the required density of LEDs over the circuit board.

The plurality of LEDs on the circuit board are electrically connected by conductive tracks between adjacent LED's and circuit boards.

Preferably the plurality of LEDs on the circuit board are electrically connected in series from a connectable power source.

The plurality of LED's can be arranged relative to each other and connected in different configurations to give different densities and allow different spacings between the front diffusing cover or substrate and LED's.

The plurality of LEDs can be in a on-linear arrangement.

Preferably the plurality of LEDs are in saw-tooth arrangement.

The plurality of LEDs in a saw-tooth arrangement can be with a selected angle between adjacent conductive tracks to provide the required density of LEDs over circuit board.

Preferably the plurality of LEDs are in a saw-tooth arrangement with the selected angle between adjacent conductive tracks to provide the required density of LEDs over circuit board being selected from the range of >0° to <180°.

More preferably the plurality of LEDs are in a saw-tooth arrangement with the selected angle between adjacent conductive tracks to provide the required density of LEDs over circuit board being selected from the range of 45° to 135°.

In a related aspect of the present invention there is provided a light emitting diode (LED) backlighting source comprising:
a circuit board formed from at least two circuit boards having a plurality of light emitting diodes (LED's), the each circuit board formed of a plurality of spaced finger portions and connecting portions, wherein the finger portions and the connecting portions are electrically connected, wherein the finger portions of the two circuit boards are releasably interconnected by frangible means in a first configuration defining a first footprint; and
wherein the at least two circuit boards are releasable by the frangible, means and reconnectable to form the circuit board having a second footprint greater than the first footprint and engage and electrically connect the at least two circuit boards in the second configuration.

In a further related aspect of the present invention there is provided a method of determining spacing of LED's and distance between front diffuser cover and LED's including

A light box comprising a translucent or semi-translucent substrate and a light emitting diode (LED) backlighting source.

Preferably the LED's can include a color rendering from a range of color variations such as ‘warm white’, or temperature changing LED's.

The invention also provides a method of forming a light emitting diode (LED) backlighting source including the steps of:

a. Determining a size of a required array formed of at least two circuit boards having a plurality of light emitting diodes (LEDs);
b. Determining the at least two circuit boards formed integrally in a first configuration as a single circuit board with a first footprint and which can be separated and reconnected to form the at least two circuit boards with a second footprint greater than the first footprint and engage and electrically connect the at least two circuit boards in the second configuration:
c. Determining a strength of light intensity required from the array;
d. Arranging plurality of light emitting diodes (LEDs) on the at least two circuit boards;
e. Forming the array from a circuit board in the first configuration
f. Frangibly separating the formed circuit board in the first configuration into the determined at least two circuit boards;
g. Electrically connecting the at least two circuit boards in the second configuration.

The method can have the plurality of LEDs are in a saw-tooth arrangement with the selected angle between adjacent conductive tracks to provide the required density of LEDs over circuit board being selected from the range of >0° to <180′.

More preferably the method has the plurality of LEDs are in a saw-tooth arrangement with the selected angle between adjacent conductive tracks to provide the required density of LEDs over circuit board being selected from the range of 45° to 135°.

The circuit board in a further aspect can be fabricated in a flexible linear roll or tape having the saw tooth configuration of LED's mounted thereon. Preferably the circuit board can include a stepped saw tooth LED configuration in a flexible linear roll of 5 metre length and 19 to 20 mm width.

Preferably the roll or tape can be manufactured in a 5 metre length with a 15 mm width. in this embodiment the flexible roll or tape can be cut to a desired length for making an array for backlighting. Preferably sections of about 600/700 mm of the flexible roll or tape can be cut and placed about 20 to 30 mm apart to form an array for backlighting.

In a further related embodiment, the flexible roll tape including LED's mounted thereon, can be cut and arranged in predetermined spacings to allow placement of a substrate such as a diffuser over the LED's at a desired distance from the LED's.

a circuit board can be fabricated from a flexible linear roil or tape of about 20 mm width having a configuration of LED's such as a saw tooth configuration, mounted thereon.

In this embodiment, the tape is to be cut to any length, and a plurality of the cut tape can be adhered to a surface in a predetermined array in which adjacent strips are spaced apart in a predetermined spacing to provide a desired distance between a substrate or diffuser and LED's.

In a further related embodiment, the circuit board formed from a roll or tape includes a stepped saw tooth LED configuration mounted on the flexible linear roll. The roll or tape is manufactured in a range of Lengths and widths but preferably 5 metre length with a 15 mm to 20 mm width. As indicated, the flexible roil or tape is cut to a desired length for making an array for backlighting. In one example, sections of the roil of about 600/700 mm are cut and placed about 20 to 30 mm apart to form an array for the backlighting. The flexible roll including LED's mounted thereon, can be cut and arranged on a surface in predetermined spacings to allow placement of a substrate such as a diffuser over the LED's at a desired distance from the LED's.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 is a diagrammatic plan view of a light emitting diode (LED) backlighting source in accordance with a first array of a preferred embodiment of the present invention;

FIG. 2 is a diagrammatic cross-sectional view of a light box using a light emitting diode (LED) backlighting source in accordance with a first array of a preferred embodiment of the present invention

FIG. 3 is a diagrammatic plan view of a light emitting diode (LED) backlighting source having array formed of two circuit boards in accordance with a preferred embodiment of the present invention;

FIG. 4 is a light emitting diode (LED) backlighting source having array formed of two circuit boards of FIG. 3 intertwined in a first configuration for manufacture with a decreased footprint;

FIG. 5 is a light emitting diode (LED) backlighting source in accordance with a first array of a preferred embodiment of the present invention showing different possible constituents;

FIG. 6 is a light emitting diode (LED) backlighting source having array formed of eight circuit boards of C-shape and I-shape that can be reconnected to form the array of FIG. 5 in accordance with a preferred embodiment of the present invention;

FIG. 7 is a light emitting diode (LED) backlighting source having array formed of thirty two circuit boards in a first configuration for manufacture with a decreased footprint formed of L-shape, I-shapes and T-shapes that can be reconnected to form the array of FIG. 5 in accordance with a preferred embodiment of the present invention; and

FIGS. 8A, 8B and 8C are details of a light emitting diode (LED) backlighting source having array showing intensity due to different spacings and different arrangements of light emitting diodes (LEDs) on the circuit boards for a method of creating a light emitting diode (LED) backlighting source according to the invention.

### DESCRIPTION OF PREFERRED EMBODIMENTS

It should be noted in the following description that like or the same reference numerals in different embodiments denote the same or similar features.

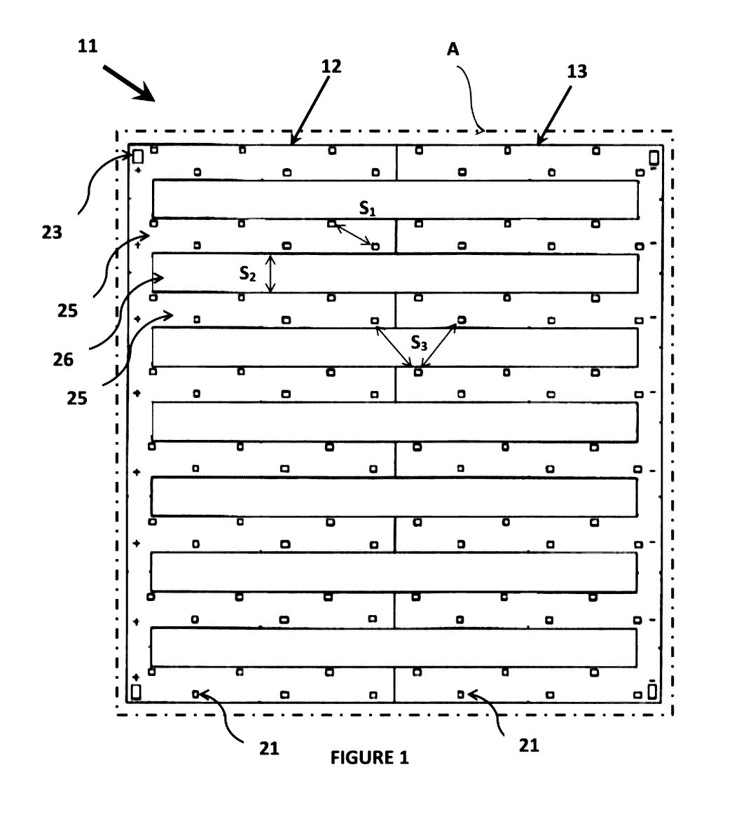

Referring to the drawings there is shown in FIG. 1 a light emitting diode (LED) backlighting source comprising at least one circuit board 11 electrically connectable to a power source (not shown) through connectors 23 and a plurality of LEDs 21 electrically mounted on the circuit board 11 and able to be powered by the connected power source.

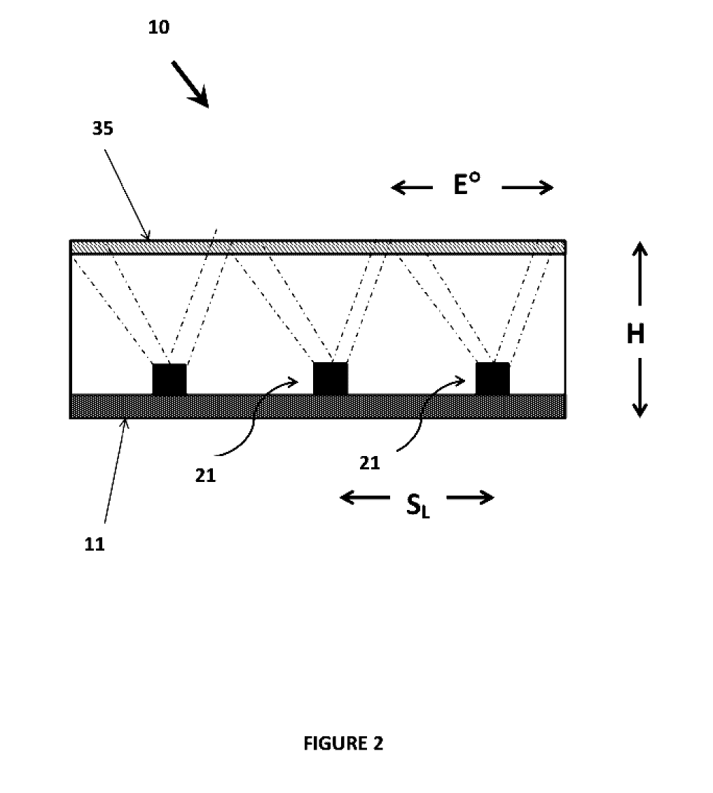

Referring to FIG. 2, there is shown an LED light source for backlighting a translucent or semitranslucent substrate 35 by way of spaced LEDs 21 on a circuit board 11 to provide a substantially uniform box light source 10 which can be used in advertising, in general illumination or in decorative light sources. The linear spacing S_{L} and the limited angle E° provides a limiting height H that the translucent or semitranslucent substrate 35 needs to be away from the spaced LEDs 21 to provide the substantially uniform light source for the box light source 10. However the versatility of the present invention breaks the shackles of this limitation as will become evident hereinafter.

Referring to FIG. 1 in further detail, there is shown that the at least one circuit board 11 of the light emitting diode (LED) backlighting source is formed by two circuit boards 12, 13 which form an array 11 having a footprint A. Each of the two circuit boards 12, 13 forms a multi-fingered E-shape wherein each circuit board is formed of a plurality of spaced finger portions 25 and connecting portions 23. The finger portions and the connecting portions are therefore electrically connected but the finger portions have spacing 26 therebetween of no circuit board 11, 12 or 13. As the circuit boards 12, 13 have circuit board sections of a plurality of spaced finger portions 25 that are spaced from each other and have empty spacings 26, the array 11 does not need to be formed by a single continuous circuit board.

Therefore the operating array of the LED light source for backlighting a translucent or semitranslucent substrate having an overall footprint of A does not need to be formed of a continuous circuit board having an overall footprint of A.

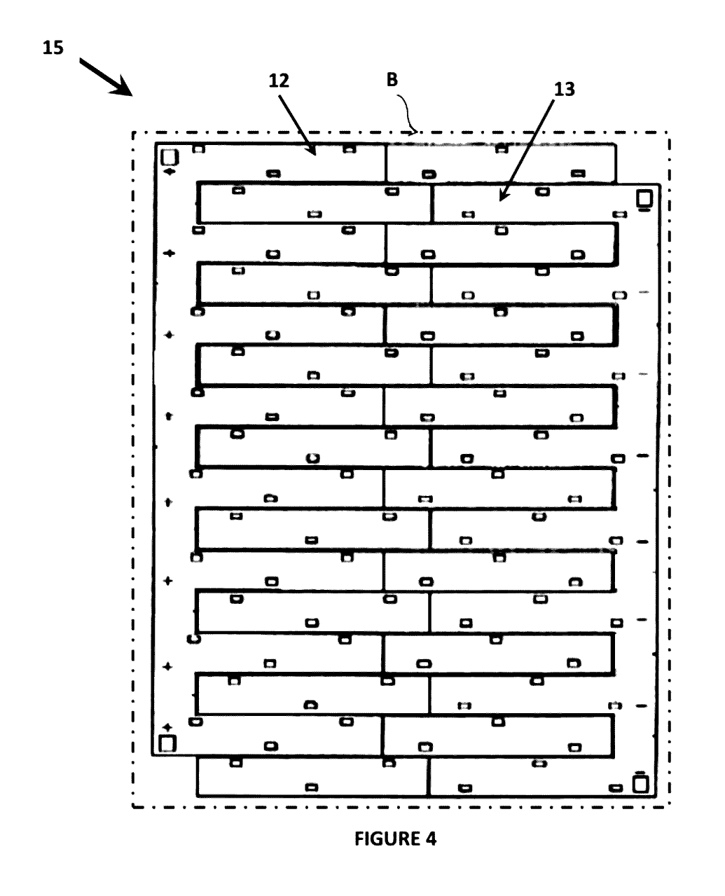

Referring in particular to FIGS. 1 and 4, the separate circuit boards 12, 13 forming the array 11 with footprint A and including spacings 26 between finger portions 25 can be created as a single circuit board as shown in first configuration for manufacture 15 in FIG. 4 with footprint B smaller than footprint A. This is achieved by the multi-fingered E-shape design of the separate circuit boards 12, 13 with the finger portions 25 of the circuit boards 12, 13 intertwining to substantially eliminate all spacings 26 in the circuit board boards 12, 13 can be frangibly disconnected from each other to form the separate multi-fingered E-shape separate circuit boards 12, 13 and thereby forming the spacings 26 between finger portions 25. The circuit boards can then be reconnected with the separate multi-fingered E-shape separate circuit boards 12, 13 having respective finger portions 25 linearly aligned.

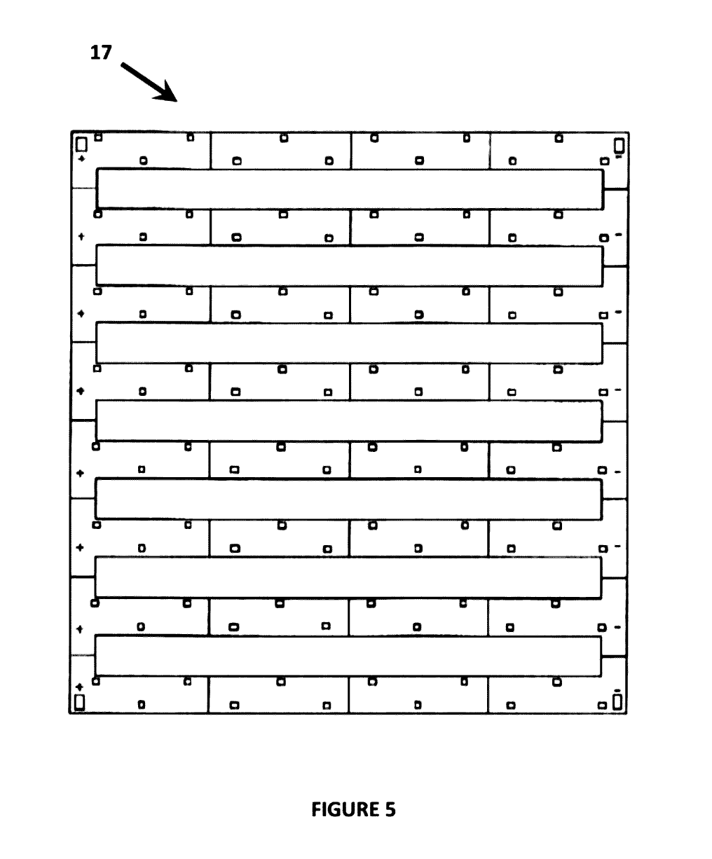

The one design of multi-fingered E-shape design of the light emitting diode (LED) backlighting source can be formed in a number of ways. Referring to FIG. 5 there is shown the multi-fingered E-shape designs broken into a range of component parts. It can be seen that the initial creation of the circuit board and resulting array can be achieved by other designs than only the multi-fingered &shape design of the separate circuit boards 12, 13 with the finger portions 25 being intertwined to substantially eliminate all spacings 26 in the circuit board creation stage as shown in FIGS. 1 and 4.

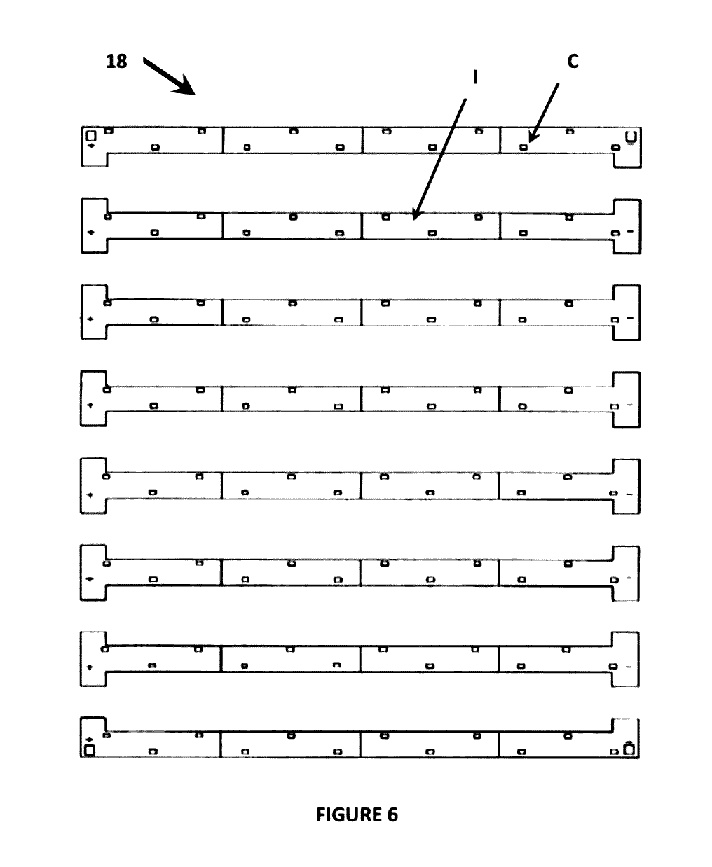

FIG. 6 shows how the multi-fingered E-shape design of the separate circuit boards 12, 13 can be formed of long C-shape (C) and I-shapes (I). This might not result in the maximum reduction in footprint from footprint A of the final array in operation from the footprint B when created as a single circuit board but it definitely will create a footprint B smaller than footprint A and allow greater versatility.

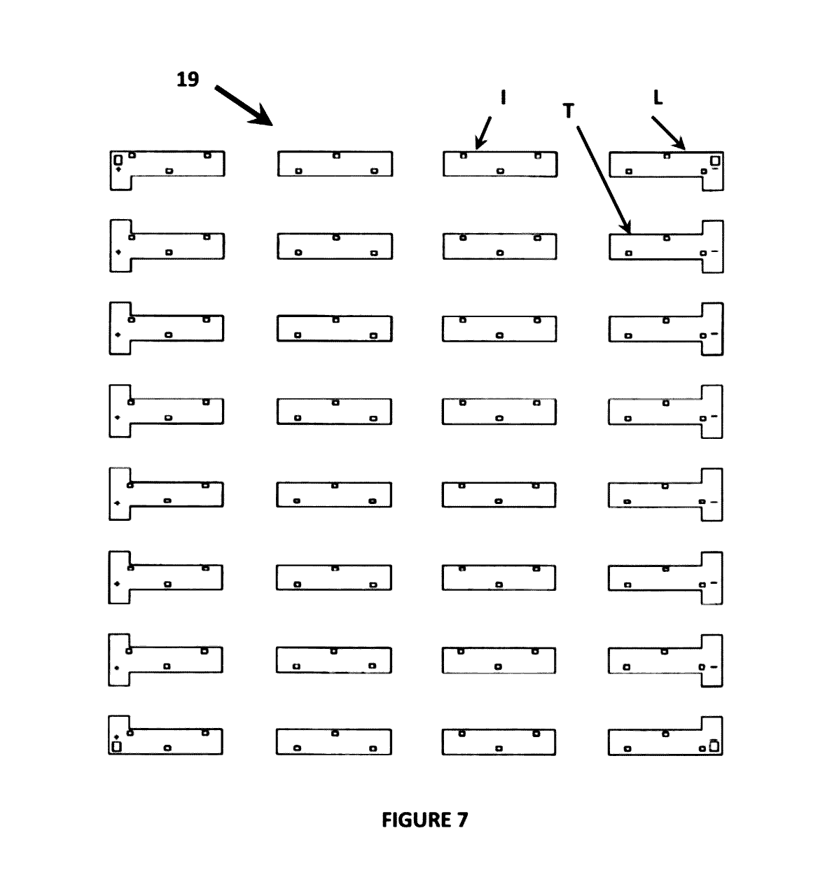

Still further as shown in FIG. 7, the multi-fingered E-shape design of the separate circuit boards 12, 13 can be formed of smaller parts of L-shape (L), T-shape (T) and I-shape parts (I) that can be made in any configuration on a single circuit board and frangibly disconnected after creation and then reformed into the opposing multi-fingered E-shape design of the separate circuit boards 12, 13, The finger portions 25 and the connecting portions 27 can also be created directly into the final array as per FIG. 5,

However the light emitting diode (LED) backlighting source is not limited to this design but is open to creation of a range of designs.

As shown in FIG. 1 there are spacing distances S₁ between adjacent LEDs 21. There are spacings 26 of no circuit board with spacing distances S₂ between adjacent finger portions 25 which creates spacing distances S₃ of LEDs 21. A design therefore is determined by a number of elements including pattern of LEDs on a particular finger portion 25, pattern of finger portions 25 themselves and, pattern of LEDs on an adjacent finger portion to the particular finger portion 25.

The light emitting diode (LED) backlighting source of the present invention has many benefits and any one or more of those benefits can be implemented into an embodiment of the invention. The various benefits comprise:
a. General ease and variability of manufacture
b. The ability to decrease circuit board manufacture size
c. The variability of size of final array
d. The variability of LED intensity of final array
e. The control of sections of LED final array

The general ease and variability of manufacture can he shown by the method of forming a light emitting diode (LED) backlighting source. Initially the physical structure of the final array with spacings can be determined. Secondly is the intensity structure that is required while maintaining constant illumination intensity across the backlighting source, This is related to the LED radiance and relative spacing. Thirdly is the effective manufacture and then disassembly and assembly into the effective array.

Therefore the initial step of the physical structure of the final array with spacings can be determined includes:
a. Determining a size of a required array formed of at least two circuit boards having a plurality of light emitting diodes (LEDs);
b. Determining the at least two circuit boards formed integrally in a first configuration as a single circuit board with a first footprint and which can be separated and reconnected to form the at least two circuit boards with a second footprint greater than the first footprint and engage and electrically connect the at least two circuit boards in the second configuration.

The second step of the intensity structure that is required while maintaining constant illumination intensity across the backlighting source includes:
a. Determining a strength of light intensity required from the array;
b. Arranging plurality of light emitting diodes (LEDs) on the at !east two circuit boards.

Third step is the effective manufacture and then disassembly and assembly into the effective array by;
a. Forming the array from a circuit board in the first configuration
b. Frangibly separating the formed circuit board in the first configuration into the determined at least two circuit boards: and
c. Electrically connecting the at least two circuit boards in the second configuration.

The ability to decrease circuit board manufacture size is shown in particular by FIG. 1 in comparison to FIG. 4.

The variability of size of final array is achieved in that all the component parts can be modular and any one part of a design can be replaced. Still further the final array is not limited to the shape or size of the circuit board on creation but can be reconfigured or expanded to the required size and shape and added to due to its design and method of creation.

The variability of LED intensity of final array is able to be modified or varied by change of design or parts and this can also allow variability of design of the final light box as the spacing from LEDs on the rear lighting circuit board from the front translucent or semitranslucent substrate 15 can be altered as required in the initial design. No longer are you limited by the fixed circuit board and fixed limitations of LEDs.

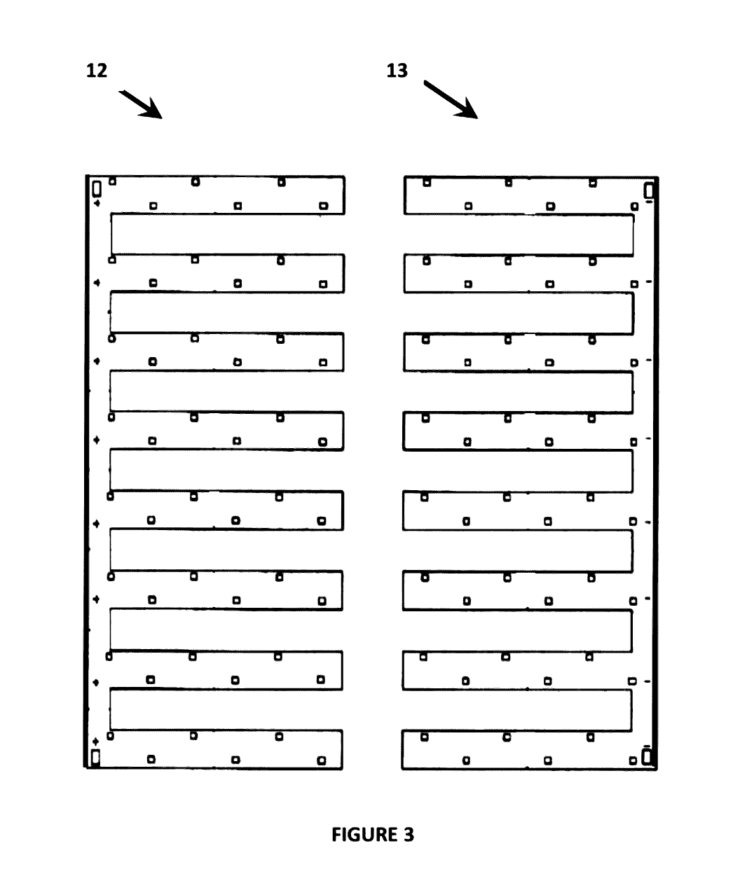

The plurality of LEDs 21 of the multi-fingered E-shape design of the separate circuit boards 12, 13 of the FIGS. 1 to 7 are in a saw-tooth arrangement with a fixed angle. However the selected angle between adjacent conductive tracks can be different in different designs to provide the required density of LEDs over circuit board being selected from the range of >0° to <180°. This is also an element which alters the spacing distances S₁ between adjacent LEDs 21. There are spacings 26 of no circuit board with spacing distances S₂ between of adjacent finger portions 25 which creates spacing distances S₃ of LEDs 21. A design Therefore is determined by a number of elements including pattern of LEDs on a particular finger portion 25, pattern of finger portions 25 themselves and, pattern of LEDs on an adjacent finger portion to the particular finger portion 25.

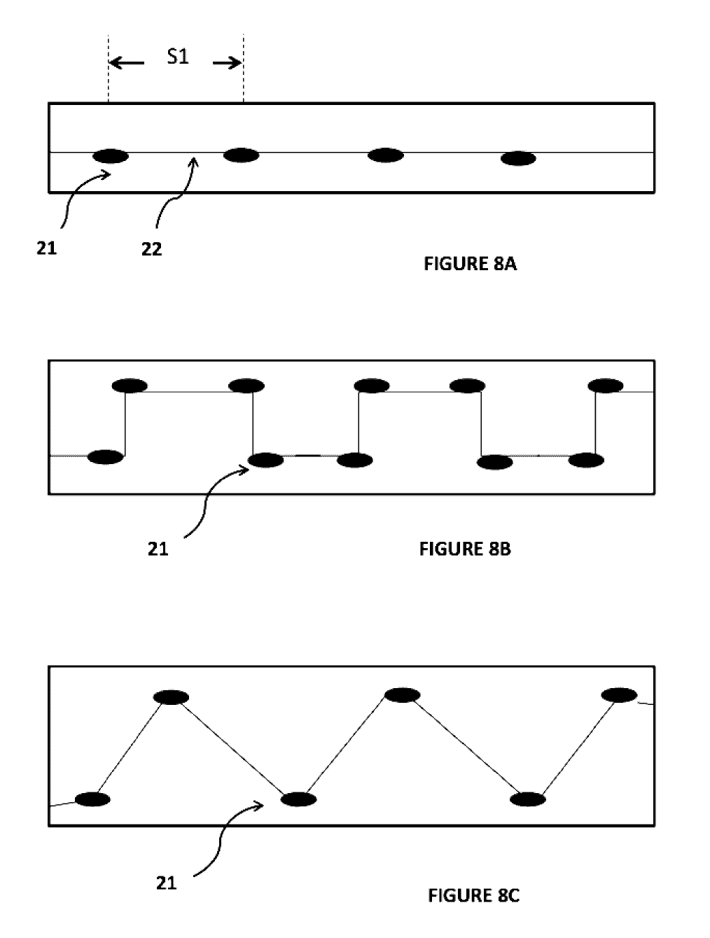

As shown in FIGS. 8A, 8B and 8C the plurality of LEDs 21 do not need to be in a saw-tooth arrangement with the selected angle between adjacent conductive tracks to provide the required density of LEDs over circuit board being selected from the range of 45° to 135°. Instead it could be linear, square wave, sinusoidal, or random. The choice of arrangement is another variable of the angle and spacing of LEDs to give different density of LEDs and thereby different intensity of light.

Also the control of sections of LED final array can be varied as sections can be separately powered and separately fluctuated.

In a further embodiment not shown), the density of LED's can be varied to achieve a predetermined backlighting effect, and depending on the density of LED's for a given finger portion, the distance between the substrate or diffuser cover 35 can be varied to optimise the predetermined effect required.

### Interpretation

### Embodiments:

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fail within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the aft that the invention may be embodied in many other forms.

### INDUSTRIAL APPLICABILITY

It is apparent from the above, that the arrangements described are applicable to the lighting or advertising industries and other light emitting diode (LED) backlighting source industries.

1. A light emitting diode (LED) backlighting source comprising:
a. at least one circuit board electrically connectable to a power source;
b a plurality of LEDs electrically mounted on the circuit board and able to be powered by a connected power source:
c. wherein the circuit board is formed of a plurality of spaced finger portions and connecting portions wherein the finger portions and the connecting portions are electrically connected.

2. A light emitting diode (LED) backlighting source according to claim 1 comprising of at least two circuit boards that have a shape and electrical configuration of the finger portions and the connecting portions to engage and to electrically connect the at least two circuit boards.

3. A light emitting diode (LED) backlighting source according to claim 1 wherein the at least two circuit boards have a substantially similar shape to each other.

4. A light emitting diode (LED) backlighting source according to claim 1 wherein the at least two circuit boards are hand portions formed by at least one connecting portions with a plurality of having

5. A light emitting diode (LED) backlighting source according to claim 1 wherein the at least two circuit boards electrically connect the finger portions of one to the finger portions of another.

6. A light emitting diode (LED) backlighting source according to claim 1 wherein the at least two circuit boards electrically connect the end tip of finger portions of one to the end tip of finger portions of another.

7. A light emitting diode (LED) backlighting source according to claim 2 wherein the at least two circuit boards are formed integrally in a first configuration as a single circuit board with a first footprint and can be separated and reconnected to form the at least two circuit boards with a second footprint greater than the first footprint and engage and electrically connect the at least two circuit boards in the second configuration.

8. A light emitting diode (LED) backlighting source according to claim 2 wherein the at least two circuit boards are formed in a first configuration.

9. A light emitting diode (LED) backlighting source according to claim 3 wherein the at least two circuit boards are complementary in shape.

10. A light emitting diode (LED) backlighting source according to claim 3 wherein the at least two circuit boards are formed from a substantially rectangular circuit board.

11. A light emitting diode (LED) backlighting source according to claim 1 wherein the LEDs are electrically mounted on the circuit board in a spaced arrangement to enhance constant illumination over the footprint of the circuit board.

12. A light emitting diode (LED) backlighting source according Co claim 1, wherein a display array is formed of a plurality of circuit boards wherein at least two circuit boards are formed integrally in a first configuration as a single circuit board with a first footprint and can be separated and reconnected to form the at least two circuit boards with a second footprint greater than the first footprint and engage and electrically connect the at least two circuit boards in the second configuration.

13. A light emitting diode (LED) backlighting source according to claim 1, wherein the plurality of LEDs on the circuit board are substantially equally spaced from each other on the circuit board.

14. A light emitting diode (LED) backlighting source according to claim 1, wherein the plurality of LEDs on the circuit board are substantially equally spaced from each other over the plurality of spaced finger portions.

15. A light emitting diode (LED) backlighting source according to any one of the preceding claims wherein the plurality of LEDs are spaced and offset to each other to provide the required density of LEDs over the circuit board.

16. A light emitting diode (LED) backlighting source according to claim 1, wherein the plurality of LEDs on the circuit board are electrically connected by conductive tracks between adjacent

17. A light emitting diode (LED) backlighting source according to claim 1, wherein the plurality of LEDs on the circuit board are electrically connected in series from a connectable power source.

18. A light emitting diode (LED) backlighting source according to claim 1, wherein the plurality of LEDs are in a non-linear arrangement.

9. A light emitting diode (LED) backlighting source according to claim 1, wherein the plurality of LEDs are in a saw-tooth arrangement with the selected angle between adjacent conductive tracks to provide the required density of LEDs over circuit board being selected from the range of 45° to 135°.

20. A method of forming a light emitting diode (LED) backlighting source including steps of:
a. Determining a size of a required array formed of at least two circuit boards having a plurality of light emitting diodes (LEDs);
b. Determining the at least two circuit boards formed integrally in a first configuration as a single circuit board with a first footprint and which can be separated and reconnected to form the at least two circuit boards with a second footprint greater than the first footprint and engage and electrically connect the at least two circuit boards in the second configuration;
c. Determining a strength of light intensity required from the array;
d. Arranging plurality of light emitting diodes (LEDs) on the at least two circuit boards;
e. Forming the array from a circuit board in the first configuration
f. Frangibly separating the formed circuit board in the first configuration into the determined at least two circuit boards; and
Electrically connecting the at least two circuit boards in the second configuration.
